(19) United States
(12) Patent Application Publication
(10) Pub. No.: US 2025/0138985 A1
(43) Pub. Date: May 1, 2025

(54) PREDICTING HARDWARE SAFETY MARGIN

(71) Applicant: SAP SE, Walldorf (DE)

(72) Inventors: Tim Breitenbach, Mitgenfeld (DE); Patrick Jahnke, Liemen (DE)

(21) Appl. No.: 18/499,926

(22) Filed: Nov. 1, 2023

(51) Int. Cl. G06F 11/36; G06F 11/30; G06F 11/34

(52) U.S. Cl. CPC G06F 11/3616; G06F 11/302; G06F 11/3452

(57) ABSTRACT

To predict hardware safety margins, historic records of hardware metrics indicating amounts of allocated and used resources for one or more software applications are obtained. Feedback metrics indicating performance issues for the software are determined based on the metrics. Then a histogram is generated plotting a frequency of the feedback metric using bins based on a difference between the allocated resources and the used resources. A threshold value is determined for the difference by iteratively determining, starting with a rightmost bin, whether data points in that bin indicate poor performance of the software based on the difference between the allocated resources and the used resources. The threshold value indicates a safety margin for operating the one software applications without performing poorly. Resources for the one or more software applications are then re-allocated according to the safety margin.

### BACKGROUND

The present disclosure relates to computer hardware allocation and in particular to predicting hardware safety margins.

Cloud companies providing software as a service (SaaS) estimate the hardware demand they need to provide their customers a smooth operation of their booked services. If the amount of allocated hardware, including servers and network infrastructure, is too small, the services may not run properly. For example, the service may run out of resources to process their tasks quickly (e.g. not enough memory is left for housekeeping or a too small gap between used and allocated memory requires extra work for efficiency to cope with the small gap) or even crash (e.g., because they run out of memory). On the other hand, an oversupply of hardware may not improve the quality of the service at some point, and it also results in an unnecessary waste of computing resources of the cloud company, and increased costs.

For existing customers, their data is obtained over years as to how much of the available hardware was used by their services. However, if new customers are acquired to use the services, there is a question of how much more hardware does the cloud company have to provide. In addition, there is also a question of how much to scale the hardware for customers as their hardware requirements grow. If there was an oversupply of allocated hardware, such scaling may cause an unnecessarily large gap between allocated hardware and used hardware, thereby decreasing the margins of the cloud business.

There is a need to determine how much available physical hardware to provide for specific services, for specific customers. In other words, what safety margin to use between the used hardware resources and the allocated or physically available hardware in order to reduce waste and maximize utilizable hardware resources.

The present disclosure addresses these issue and others, as further described below.

### SUMMARY

Some embodiments provide a computer system, comprising one or more processors and one or more machine-readable medium coupled to the one or more processors. The machine-readable medium storing computer program code comprising sets of instructions executable by the one or more processors. The instructions are executable to obtain historic records of hardware metrics for one or more software applications, the hardware metrics including an amount of allocated resources allocated to the one or more software applications and an amount of used resources used by the one or more software applications. The instructions are further executable to determine feedback metrics for the software application based on the hardware metrics or based on software metrics for the one or more software applications, the feedback metrics indicating whether the one or more software applications experienced performances issues. The instructions are further executable to generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded. The instructions are further executable to determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly. Furthermore, resources for the one or more software applications are then re-allocated according to the safety margin.

Some embodiments provide one or more non-transitory computer-readable medium storing computer program code. The computer program code comprises sets of instructions to obtain historic records of hardware metrics for one or more software applications, the hardware metrics including an amount of allocated resources allocated to the one or more software applications and an amount of used resources used by the one or more software applications. The computer program code further comprises sets of instructions to determine feedback metrics for the software application based on the hardware metrics or based on software metrics for the one or more software applications, the feedback metrics indicating whether the one or more software applications experienced performances issues. The computer program code further comprises sets of instructions to generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded. The computer program code further comprises sets of instructions to determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly. Resources for the one or more software applications are then re-allocated according to the safety margin.

Some embodiments provide a computer-implemented method. The method comprises obtaining historic records of hardware metrics for one or more software applications, the hardware metrics including an amount of allocated resources allocated to the one or more software applications and an amount of used resources used by the one or more software applications. The method further comprises determining feedback metrics for the software application based on the hardware metrics or based on software metrics for the one or more software applications, the feedback metrics indicating whether the one or more software applications experienced performances issues. The method further comprises generating a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded. The method further comprises determining a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly. Resources for the one or more software applications are then re-allocated according to the safety margin.

### BRIEF DESCRIPTION OF THE DRAWINGS

FIG. 1 shows a diagram of a computer system in a cloud platform, according to an embodiment.

FIG. 2 shows a flowchart of a computer implemented method for predicting hardware safety margins, according to an embodiment.

FIG. 3 shows a histogram of the weighted relative frequency of data points with a performance issue by the difference between available and used computing resources, according to an embodiment.

FIG. 4 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

In the figures and their corresponding description, while certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. As used herein, the terms “first,” “second,” “third,” “fourth,” etc., do not necessarily indicate an ordering or sequence unless indicated and may instead be used for differentiation between different objects or elements.

As mentioned above, Cloud companies providing software as a service (SaaS) estimate the hardware demand they need to provide their customers a smooth operation of their booked services. If the amount of allocated hardware, including servers and network infrastructure, is too small, the services may not run properly. For example the service may run out of resources to process their tasks quickly or even crash (e.g., because they run out of memory) or need to spend too much of their resources to trigger further efficiency to cope with the small gap between used and free resources. On the other hand, an oversupply of hardware may not improve the quality of the service at some point, and it also results in an unnecessary waste of computing resources of the cloud company, and increased costs.

For existing customers, their data is obtained over years as to how much of the available hardware was used by their services. However, if new customers are acquired to use the services, there is a question of how much more hardware does the cloud company have to provide. In addition, there is also a question of how much to scale the hardware for customers as their hardware requirements grow. If there was an oversupply of allocated hardware, such scaling may cause an unnecessarily large gap between allocated hardware and used hardware, thereby decreasing the margins of the cloud business.

There is a need to determine how much available physical hardware to provide for specific services, for specific customers. In other words, what safety margin to use between the used hardware resources and the allocated or physically available hardware in order to reduce waste and maximize utilizable hardware resources. The present disclosure provides techniques for predicting hardware safety margins.

As used herein, “safety margin” refers to an amount of allocated hardware provided for one or more software applications, customer-specific if necessary, which meets or exceeds the expected demand of those applications such that they do not, or rarely, encounter performance issues.

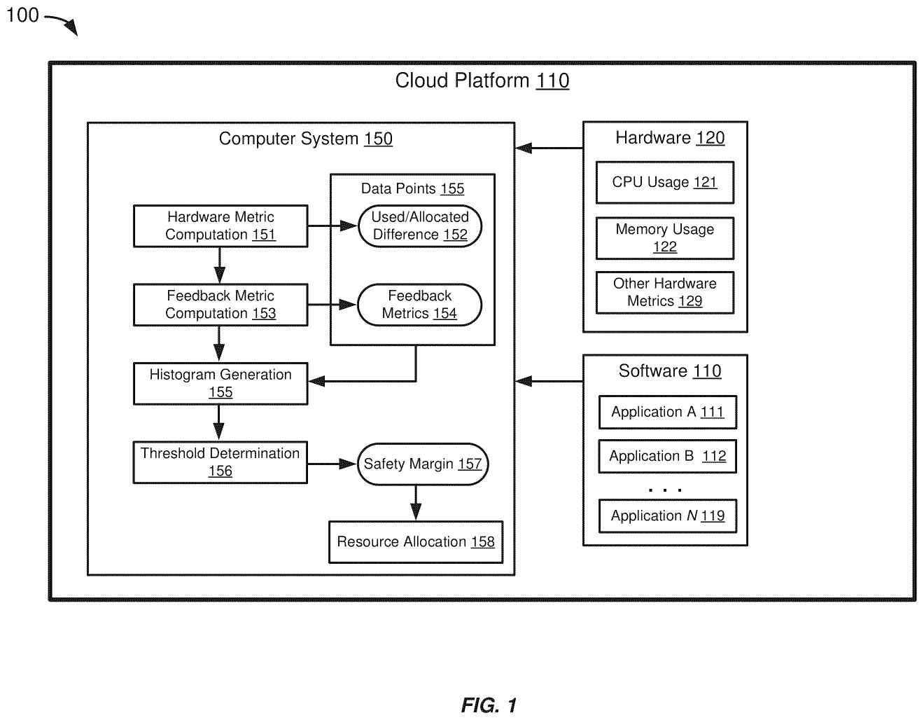

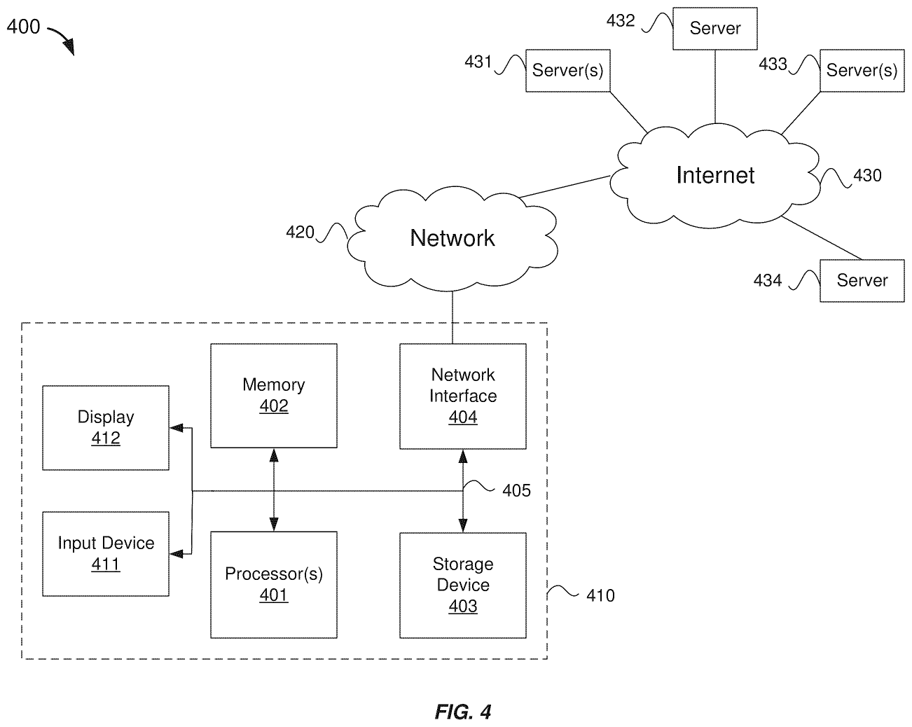

FIG. 1 shows a diagram 100 of a computer system 150 in a cloud platform 110 configured to perform statistical analysis of hardware metrics for predictive maintenance, according to an embodiment. The computer system 150 may be a server computer, for example. The computer system 150 may also include a plurality of computer devices working as a system. The computer system 150 may include computer hardware components such as those described below with respect to FIG. 4. The computer system 150 may be part of a cloud computing platform 110 providing services to one or more customers to run one or more software applications 110 on computer hardware 120. The computer system 150 is configured to determine hardware safety margins for operating the software applications 110 on the hardware 120, as further discussed below.

The computer system 150 may determine a safety margin 157 for hardware resources 120 using a hardware metric computation 151 software component, a feedback metric computation 153 software component, a histogram generation 155 software component, and a threshold determination 156 software component.

To determine the safety margin in a data driven manner, hardware metrics of the hardware 120 are collected. The hardware 120 is connected to the computer system 150 and provides historic data records of the used hardware of the entities the services run on, such as servers, virtual machines (VMs), and routers or switches. The computer system 150 may obtain historic records of hardware metrics for one or more software applications 110, as operating on the hardware 120. The hardware metrics may include an amount of allocated resources allocated to the one or more software applications and an amount of used resources used by the one or more software applications.

The metrics may also include other metrics indicative of software performance. For example, the metrics data can include metrics for CPU usage 121, memory usage 122, and other hardware metrics 129, such as network metrics including latency. In some embodiments one hardware metric may be used. In other embodiments multiple hardware metrics may be weighted and combined into a single metric.

Such hardware metrics may include contention metrics for the CPU measuring how long a service needs to wait for free CPU resources. Further, for memory resources, swapping of content intended for the memory to the storage might serve as feedback that there is a shortage of memory and thus the remaining memory resources may be too small to run the service as intended since the swapping would not be necessary if the gap was bigger and triggers unnecessary workload just for housekeeping that is not available for the customer requests. In other embodiments other hardware metrics may be used.

The hardware metrics also include the amount of resources being used and the amount of resources allocated. The difference between the allocated and the used resources computed and used along with feedback metrics to determine (predict) a safety margin as further discussed below.

The computer system 150 is configured to determine feedback metrics 154 for the software application 110 based on the hardware metrics or based on software metrics for the one or more software applications. Such metrics may be obtained (or computed based on information obtained from) the software applications 110. As shown in FIG. 1, one or more applications may be operated by the cloud platform 110, including Application A 111, Application B 112, on up to any number of applications, including Application N 119.

The feedback metrics 154 may indicate whether the one or more software applications experienced performances issues. For example, a metric or event (e.g., out of memory event, swapping, contention, etc.) from the software 110 may serve as a proxy for quality of operation.

As one example, a database application may provide several metrics measuring poor performance (e.g., disadvantageous events), such as “process allocation limit out of memory dumps” and “global out of memory dumps.” In this example, these events are clear indicators that too little memory is left for the software to function properly since tables in the memory are dumped to free resources.

As another example, for network devices such a feedback metric can be that for some left bandwidth the internal memory is used to buffer received messages before sending or packet drops on a device.

As mentioned above, metrics and data can be obtained from the hardware 120 of the cloud platform 110 and from the software 110 operating on the cloud platform. From this information the computer system 150 may determine data points 155. Each data point consists of the difference 152 of the allocated hardware resource (e.g., amount that it is possible to use) and the currently used resource (labeled as “D”) and the corresponding value 154 of the feedback metric (labeled as “F”).

The hardware metric computation 151 component is configured to determine the difference 152 between the allocated hardware and the used hardware based on metrics or data obtained from the hardware 120.

The feedback metric computation 153 component is configured to determine the values 154 of the feedback metric based on either the hardware metrics (e.g., CPU usage 121, memory usage 122, or other hardware metrics 129) or based on metrics or events from the software 110, such as out of memory events and other poor performance indicators.

Furthermore, since the safety margin 157 may depend on the type of software application 110 or scenario the service is used in, the data points 155 may be divided into subgroups accordingly and separately investigated. This may be done because different types of applications may have different safety margins because they execute in a different fashion. For example, a database application may execute different from a JAVA application and applications of these two types may be subgrouped with their own type. Depending on a subgroup definition, the accuracy and sharpness of the safety margins may increase.

Using the datapoints 155, the histogram generation 155 software component is configured to generate a histogram plotting a frequency of the feedback metric using bins based on a difference 152 between the allocated resources and the used resources. The data points 155 used to generate the histogram are a pair includes a difference 152 value and a feedback metric value 154. The difference values 152 are a particular difference between allocated resources and used resources when the corresponding feedback metric value was recorded.

The threshold determination 156 software component is configured to determine a threshold value for the difference between the allocated resources and the used resources. The threshold value indicates the safety margin 157 for operating the one or more software applications (e.g., without performing poorly).

The threshold value may be determined by iteratively determining, starting with a rightmost bin of the histogram, whether a number of data points in that bin indicate poor performance of the one or more software applications based on the difference between the allocated resources and the used resources.

Once the safety margin 157 is determined, the resource allocation 158 software component is configured to re-allocated the hardware 120 resources for the one or more software applications 110 according to the safety margin 158. As mentioned above, different types of applications may be subgrouped. In this case, different safety margins 157 may be determined for each subgroup of application and the resources for the different subgroups may be allocated according to their corresponding safety margin 157.

Features and advantages of the techniques for predicting hardware safety margins include reducing waste caused by unused computer hardware and improved efficiency in utilizing computer hardware given the accuracy of the safety margin (e.g., closeness to the threshold for poor performance of the software).

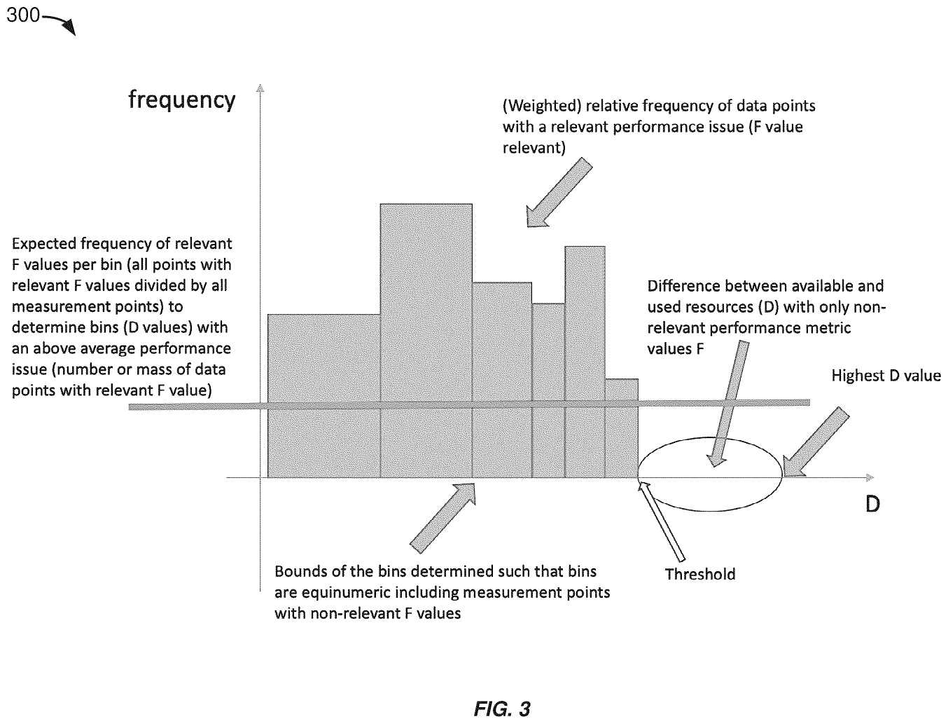

Further details of the generated histogram and additional statistical techniques are described below with respect to FIG. 3. The computer system 150 may further implement the techniques described below with respect to FIG. 3.

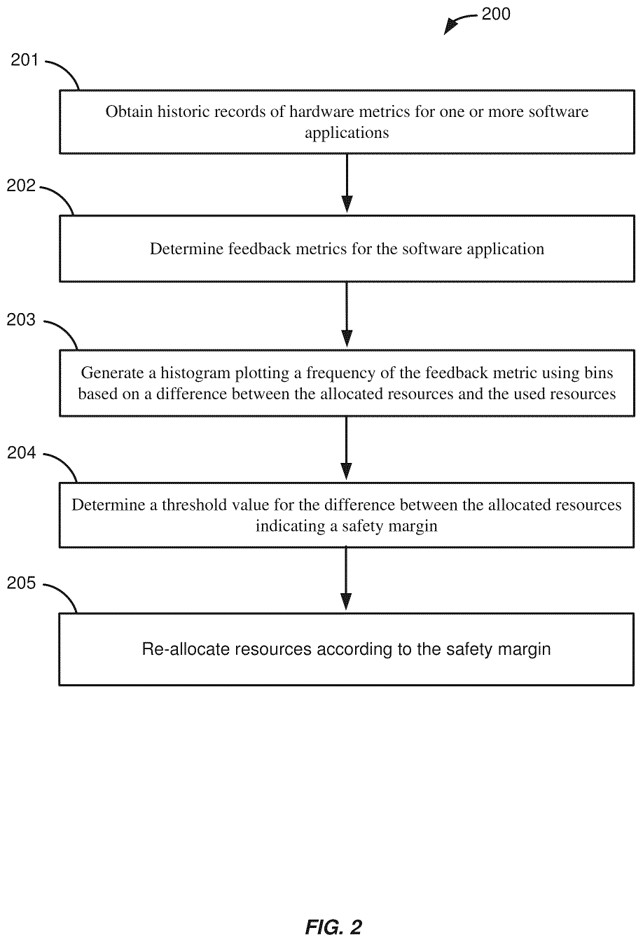

FIG. 2 shows a flowchart 200 of a computer implemented method for predicting hardware safety margins, according to an embodiment. This method may be performed by a computer system such as the computer system 150 described above with respect to FIG. 1.

At 201, obtain historic records of hardware metrics for one or more software applications, the hardware metrics including an amount of allocated resources allocated to the one or more software applications and an amount of used resources used by the one or more software applications.

At 202, determine feedback metrics for the software application based on the hardware metrics or based on software metrics for the one or more software applications, the feedback metrics indicating whether the one or more software applications experienced performances issues.

At 203, generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded.

At 204, determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly.

At 205, resources for the one or more software applications are re-allocated according to the safety margin.

In some embodiments, the flowchart 200 may further check, using a statistical test, a hypothesis that a bin of the histogram has more values for the frequency of the feedback metric than an expected number of values by comparing the total measurement points in that histogram bin and values above a tolerable value.

In some embodiments, the flowchart 200 may further determine data points where the feedback metric is equal to or below a tolerance threshold and remove the data points equal or below the tolerance threshold such that they are not used to generate the histogram.

In some embodiments, the flowchart 200 may further determine the bins of the histogram are equidistant and divide, after removing the data points equal or below the tolerance threshold, a number of data points in each bin by a total number of data points in the corresponding bin including the points equal or below the threshold.

In some embodiments, the flowchart 200 may further calculate an expected mass of data points per bin and calculate a likeliness for a deviation between the mass for each particular bin and an average mass per bin, where a likeliness equal to or below a likeliness threshold value indicates that the poor performance of the one or more software applications is not a coincidence.

In some embodiments, the one or more software applications are operated by a cloud computing platform, and wherein reallocation of the resources for the one or more software applications includes reserving memory of the cloud computing platform for the one or more software applications.

In some embodiments, software metrics for the one or more software applications include metrics for one or more of out of memory dumps, other memory shortages or events, and software crashes.

### EXAMPLE EMBODIMENTS

Techniques for predicting hardware safety margins were described above. Now an example histogram is described along with additional statistical methods.

FIG. 3 shows a histogram 300 of the weighted relative frequency of data points with a performance issue (F) by the difference between available and used computing resources (D), according to an embodiment.

FIG. 3 shows the difference between available and used computing resources (D) along the x-axis and the weighted relative frequency of data points with a performance issue (F) along the y-axis. The bounds of the bins of the histogram 300 may be determined such that the bins are equinumeric including measurement points with non-relevant F values (e.g., not having performance issues). FIG. 3 also shows a horizontal line for the expected frequency per bin to calculate probability to exceed it by some value. As further discussed below, this horizontal line indicates when the performance issues are no longer deemed to be a coincidence, and thus it can be used to determine the safety margin. FIG. 3 also shows where the “threshold” value is along the histogram. FIG. 3 also shows a circle around bins in which the difference between available and used resources (D) with only performance metric values (F), which are data points where the software applications did not experience performance issues, or only a number of performance issues which were tolerable or that could be attributed to coincidence.

Techniques for generating the histogram 300 are now described. These techniques build upon the techniques described above with respect to FIGS. 1 and 2. First, the data points are binned together according to the difference between available and used resources (D) such that each bin has the same number of data points. Furthermore, it may be ensured that this number is large enough to be able to do subsequent statistical tests, and be robust against outliers.

Next, all data points are removed where the value of the frequency of data points with a performance issue (F) is below or equal some tolerance (e.g., 0 out of memory dumps or swapping that is tolerable up to some number). The F value is a metric that measures performance issues or is a proxy for performance issues of an application or impact on a customer or application. Then, the safety margin may be determined by iteratively going through the bins starting from the one with the highest D values (labeled in FIG. 3) and going from right to left through each of the bins until it is determined that particular bin has a significant number of data points left in that interval. This means that the bin has a significant occurrence of events associated with poor performance for such D values.

In the case where the bins are equidistant with respect to D, it can be the case that they consist of a different number of data points. In this case, the number of points in that bin is divided, (after removing the data points where the F value is below the tolerable threshold) by the total number of data points in the bin to account for the different data foundation of each bin. In order to take also the values of F into account and not only the number of measure points with a relevant F-value, we can sum up F values in each bin. In other words, this weighs each relevant F value with the corresponding performance impact.

Optionally, we can use a suitable statistical test to check a hypothesis that a bin has more F values than to be expected by comparing the total measurement points in that bin and the measurement points with F values above the tolerable value with the expected number of measurements points with F values above the tolerable value.

For example, the expected rate for a binomial distribution may be calculated by dividing all F values above the tolerable threshold by all measurement values. Then the likeliness of the hypothesis to have more than the observed number of F values k above the tolerable threshold in one bin is tested, assuming equal distribution of these values among the bins. If it is unlikely that under the hypothesis of equally distributed relevant F values, then the first bin (starting from the biggest D values) where we need to reject equal distribution defines the threshold for the gap between allocated and used resources.

In case of summed up F values in each bin (instead of just the number of F values), an expected mass of F per bin is calculated (taking scaled mass into account in case bins do not have a balanced data foundation) and then (e.g. with a suitable statistical test, like t- or Welch's test) the likeliness for a deviation between the mass in the bin and the average mass per bin is calculated. If the likeliness is too small (e.g., equal to or less a likeliness threshold) that a deviation is coincidence, it is determined that the increased number of F value comes from issues that are present due to a too small difference between available and used resources.

By applying the corresponding safety margin to each expected utilization of a service provided to a customer, the hardware needed to provide a smooth operation can be estimated by summing up the need hardware resources (including the safety margin) of each entity (application subgroup). The expected utilization can be inferred from historic data.

For the classification in which the safety margins were specifically calculated, the utilization of each time point and each entity can be summed up. Then a predetermined percentile, like the 99%- or 100%-percentile (=maximum), of the values of the summed up values over all time points within (e.g. the last year) can serve as an estimation of hardware utilized by the users assuming that the user number will be the same in the next year.

Features and advantages of the techniques for predicting hardware safety margins further include the ability to predictively scale hardware over time. Suppose that the number of customers/users will vary, this used hardware estimation can be scaled with the same factor as the customers scale assuming that the new customers have the same user pattern as past customers (e.g., a user booking a service in the future period will use it with the same intensity as in the past). The hardware demand estimation is done as in the case of constant users once the used hardware is estimated.

### Example Hardware

FIG. 4 shows a diagram 400 of hardware of a special purpose computing machine for implementing systems and methods described herein. The following hardware description is merely one example. It is to be understood that a variety of computers topologies may be used to implement the above described techniques. For instance, the computer system may implement the computer implemented method described.

An example computer system 410 is illustrated in FIG. 4. Computer system 410 includes a bus 405 or other communication mechanism for communicating information, and one or more processor(s) 401 coupled with bus 405 for processing information. Computer system 410 also includes a memory 402 coupled to bus 405 for storing information and instructions to be executed by processor 401, including information and instructions for performing some of the techniques described above, for example. This memory 402 may also be used for storing programs executed by processor(s) 401. Possible implementations of this memory may be, but are not limited to, random access memory (RAM), read only memory (ROM), or both. As such, the memory 402 is a non-transitory computer readable storage medium.

A storage device 403 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 403 may include source code, binary code, or software files for performing the techniques above, for example. Storage device and memory are both examples of non-transitory computer readable storage mediums. For example, the storage device 403 may store computer program code including instructions for implementing the method described above with respect to FIG. 2.

Computer system 410 may be coupled using bus 405 to a display 412 for displaying information to a computer user. An input device 411 such as a keyboard, touchscreen, and/or mouse is coupled to bus 405 for communicating information and command selections from the user to processor 401. The combination of these components allows the user to communicate with the system. In some systems, bus 405 represents multiple specialized buses, for example.

Computer system also includes a network interface 404 coupled with bus 405. Network interface 404 may provide two-way data communication between computer system 410 and a network 420. The network interface 404 may be a wireless or wired connection, for example. Computer system 410 can send and receive information through the network interface 404 across a local area network, an Intranet, a cellular network, or the Internet, for example. In the Internet example, a browser, for example, may access data and features on backend systems that may reside on multiple different hardware servers 431, 432, 433, 434 across the network. The servers 431-434 may be part of a cloud computing environment, for example.

### Additional Embodiments

Additional embodiments are described below.

Some embodiments provide a computer system, comprising one or more processors and one or more machine-readable medium coupled to the one or more processors. The machine-readable medium storing computer program code comprising sets of instructions executable by the one or more processors. The instructions are executable to obtain historic records of hardware metrics for one or more software applications, the hardware metrics including an amount of allocated resources allocated to the one or more software applications and an amount of used resources used by the one or more software applications. The instructions are further executable to determine feedback metrics for the software application based on the hardware metrics or based on software metrics for the one or more software applications, the feedback metrics indicating whether the one or more software applications experienced performances issues. The instructions are further executable to generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded. The instructions are further executable to determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly. Furthermore, resources for the one or more software applications are then re-allocated according to the safety margin.

In some embodiments, the instructions are further executable to check, using a statistical test, a hypothesis that a bin of the histogram has more values for the frequency of the feedback metric than an expected number of values by comparing the total measurement points in that histogram bin and values above a tolerable value.

In some embodiments, the instructions are further executable to determine data points where the feedback metric is equal to or below a tolerance threshold and to remove the data points below the tolerance threshold such that they are not used to generate the histogram.

In some embodiments, the instructions are further executable to determine the bins of the histogram are equidistant and to divide, after removing the data points below the tolerance threshold, a number of data points in each bin by a total number of data points in the corresponding bin if the bins are equidistant.

In some embodiments, the instructions are further executable to calculate an expected mass of data points per bin and to calculate a likeliness for a deviation between the mass for each particular bin and an average mass per bin, wherein a likeliness equal to or below a likeliness threshold value indicates that the poor performance of the one or more software applications is not a coincidence.

In some embodiments, the instructions are further executable to the one or more software applications are operated by a cloud computing platform, and wherein reallocation of the resources for the one or more software applications includes reserving memory of the cloud computing platform for the one or more software applications.

In some embodiments, the instructions are further executable to software metrics for the one or more software applications include metrics for one or more of out of memory dumps, other memory shortages or events, software crashes, and metrics associated with performance issues.

Some embodiments provide one or more non-transitory computer-readable medium storing computer program code. The computer program code comprises sets of instructions to obtain historic records of hardware metrics for one or more software applications, the hardware metrics including an amount of allocated resources allocated to the one or more software applications and an amount of used resources used by the one or more software applications. The computer program code further comprises sets of instructions to determine feedback metrics for the software application based on the hardware metrics or based on software metrics for the one or more software applications, the feedback metrics indicating whether the one or more software applications experienced performances issues. The computer program code further comprises sets of instructions to generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded. The computer program code further comprises sets of instructions to determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly. Resources for the one or more software applications are then re-allocated according to the safety margin.

In some embodiments, the computer program code further comprises sets of instructions to check, using a statistical test, a hypothesis that a bin of the histogram has more values for the frequency of the feedback metric than an expected number of values by comparing the total measurement points in that histogram bin and values above a tolerable value.

In some embodiments, the computer program code further comprises sets of instructions to determine data points where the feedback metric is equal to or below a tolerance threshold and to remove the data points below the tolerance threshold such that they are not used to generate the histogram.

In some embodiments, the computer program code further comprises sets of instructions to determine the bins of the histogram are equidistant and to divide, after removing the data points below the tolerance threshold, a number of data points in each bin by a total number of data points in the corresponding bin if the bins are equidistant.

In some embodiments, the computer program code further comprises sets of instructions to calculate an expected mass of data points per bin and to calculate a likeliness for a deviation between the mass for each particular bin and an average mass per bin, wherein a likeliness equal to or below a likeliness threshold value indicates that the poor performance of the one or more software applications is not a coincidence.

In some embodiments, the one or more software applications are operated by a cloud computing platform, and wherein reallocation of the resources for the one or more software applications includes reserving memory of the cloud computing platform for the one or more software applications.

In some embodiments, software metrics for the one or more software applications include metrics for one or more of out of memory dumps, other memory shortages or events, software crashes, and metrics associated with performance issues.

Some embodiments provide a computer-implemented method. The method comprises obtaining historic records of hardware metrics for one or more software applications, the hardware metrics including an amount of allocated resources allocated to the one or more software applications and an amount of used resources used by the one or more software applications. The method further comprises determining feedback metrics for the software application based on the hardware metrics or based on software metrics for the one or more software applications, the feedback metrics indicating whether the one or more software applications experienced performances issues. The method further comprises generating a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded. The method further comprises determining a threshold value for the difference between the allocated resources and the used resources by iteratively determining, starting with a rightmost bin of the histogram, whether a number of data points in that bin indicate poor performance of the one or more software applications based on the difference between the allocated resources and the used resources. The threshold value indicates a safety margin for operating the one or more software applications without performing poorly. Resources for the one or more software applications are then re-allocated according to the safety margin.

In some embodiments, the method further comprises checking, using a statistical test, a hypothesis that a bin of the histogram has more values for the frequency of the feedback metric than an expected number of values by comparing the total measurement points in that histogram bin and values above a tolerable value.

In some embodiments, the method further comprises determining data points where the feedback metric is equal to or below a tolerance threshold and removing the data points below the tolerance threshold such that they are not used to generate the histogram.

In some embodiments, the method further comprises determining the bins of the histogram are equidistant and dividing, after removing the data points below the tolerance threshold, a number of data points in each bin by a total number of data points in the corresponding bin if the bins are equidistant.

In some embodiments, the method further comprises calculating an expected mass of data points per bin and calculating a likeliness for a deviation between the mass for each particular bin and an average mass per bin, wherein a likeliness equal to or below a likeliness threshold value indicates that the poor performance of the one or more software applications is not a coincidence.

In some embodiments, the one or more software applications are operated by a cloud computing platform, and wherein reallocation of the resources for the one or more software applications includes reserving memory of the cloud computing platform for the one or more software applications.

In some embodiments software metrics for the one or more software applications include metrics for one or more of out of memory dumps, other memory shortages or events, software crashes, and metrics associated with performance issues.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors; and
one or more machine-readable medium coupled to the one or more processors and storing computer program code comprising sets of instructions executable by the one or more processors to:
obtain historic records of hardware metrics for one or more software applications, the hardware metrics including an amount of allocated resources allocated to the one or more software applications and an amount of used resources used by the one or more software applications;
determine feedback metrics for the software application based on the hardware metrics or based on software metrics for the one or more software applications, the feedback metrics indicating whether the one or more software applications experienced performances issues;
generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded; and
determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources,
wherein the threshold value indicates a safety margin for operating the one or more software applications without performing poorly, and
wherein resources for the one or more software applications are re-allocated according to the safety margin.

2. The computer system of claim 1, wherein the computer program code further comprises sets of instructions executable by the one or more processors to:
check, using a statistical test, a hypothesis that a bin of the histogram has more values for the frequency of the feedback metric than an expected number of values by comparing the total measurement points in that histogram bin and values above a tolerable value.

3. The computer system of claim 1, wherein the computer program code further comprises sets of instructions executable by the one or more processors to:
determine data points where the feedback metric is equal to or below a tolerance threshold; and
remove the data points below the tolerance threshold such that they are not used to generate the histogram.

4. The computer system of claim 3, wherein the computer program code further comprises sets of instructions executable by the one or more processors to:
determine the bins of the histogram are equidistant; and
divide, after removing the data points below the tolerance threshold, a number of data points in each bin by a total number of data points in the corresponding bin if the bins are equidistant.

5. The computer system of claim 3, wherein the computer program code further comprises sets of instructions executable by the one or more processors to:
calculate an expected mass of data points per bin; and
calculate a likeliness for a deviation between the mass for each particular bin and an average mass per bin, wherein a likeliness equal to or below a likeliness threshold value indicates that the poor performance of the one or more software applications is not a coincidence.

6. The computer system of claim 1, wherein the one or more software applications are operated by a cloud computing platform, and wherein reallocation of the resources for the one or more software applications includes reserving memory of the cloud computing platform for the one or more software applications.

7. The computer system of claim 1, wherein software metrics for the one or more software applications include metrics for one or more of out of memory dumps, other memory shortages or events, software crashes, and metrics associated with performance issues.

8. One or more non-transitory computer-readable medium storing computer program code comprising sets of instructions to:
obtain historic records of hardware metrics for one or more software applications, the hardware metrics including an amount of allocated resources allocated to the one or more software applications and an amount of used resources used by the one or more software applications;
determine feedback metrics for the software application based on the hardware metrics or based on software metrics for the one or more software applications, the feedback metrics indicating whether the one or more software applications experienced performances issues;
generate a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded; and
determine a threshold value for the difference between the allocated resources and the used resources by iteratively determining, starting with a rightmost bin of the histogram, whether a number of data points in that bin indicate poor performance of the one or more software applications based on the difference between the allocated resources and the used resources,
wherein the threshold value indicates a safety margin for operating the one or more software applications without performing poorly, and
wherein resources for the one or more software applications are re-allocated according to the safety margin.

9. The non-transitory computer-readable medium of claim 8, wherein the computer program code further comprises sets of instructions to:
check, using a statistical test, a hypothesis that a bin of the histogram has more values for the frequency of the feedback metric than an expected number of values by comparing the total measurement points in that histogram bin and values above a tolerable value.

10. The non-transitory computer-readable medium of claim 8, wherein the computer program code further comprises sets of instructions to:
determine data points where the feedback metric is equal to or below a tolerance threshold; and
remove the data points below the tolerance threshold such that they are not used to generate the histogram.

11. The non-transitory computer-readable medium of claim 10, wherein the computer program code further comprises sets of instructions to:
determine the bins of the histogram are equidistant; and
divide, after removing the data points below the tolerance threshold, a number of data points in each bin by a total number of data points in the corresponding bin if the bins are equidistant.

12. The non-transitory computer-readable medium of claim 10, wherein the computer program code further comprises sets of instructions to:
calculate an expected mass of data points per bin; and
calculate a likeliness for a deviation between the mass for each particular bin and an average mass per bin, wherein a likeliness equal to or below a likeliness threshold value indicates that the poor performance of the one or more software applications is not a coincidence.

13. The non-transitory computer-readable medium of claim 8, wherein the one or more software applications are operated by a cloud computing platform, and wherein reallocation of the resources for the one or more software applications includes reserving memory of the cloud computing platform for the one or more software applications.

14. The non-transitory computer-readable medium of claim 8, wherein software metrics for the one or more software applications include metrics for one or more of out of memory dumps, other memory shortages or events, software crashes, and metrics associated with performance issues.

15. A computer-implemented method, comprising:
obtaining historic records of hardware metrics for one or more software applications, the hardware metrics including an amount of allocated resources allocated to the one or more software applications and an amount of used resources used by the one or more software applications;
determining feedback metrics for the software application based on the hardware metrics or based on software metrics for the one or more software applications, the feedback metrics indicating whether the one or more software applications experienced performances issues;
generating a histogram plotting a frequency of the feedback metric using bins based on a difference between the allocated resources and the used resources, wherein data points used to generate the histogram are a pair including a difference value and a feedback metric value, the difference values being a particular difference between allocated resources and used resources when the corresponding feedback metric value was recorded; and
determining a threshold value for the difference between the allocated resources and the used resources by iteratively determining, starting with a rightmost bin of the histogram, whether a number of data points in that bin indicate poor performance of the one or more software applications based on the difference between the allocated resources and the used resources,
wherein the threshold value indicates a safety margin for operating the one or more software applications without performing poorly, and
wherein resources for the one or more software applications are re-allocated according to the safety margin.

16. The computer-implemented method of claim 15, wherein the computer program code further comprises sets of instructions executable by the one or more processors to:
checking, using a statistical test, a hypothesis that a bin of the histogram has more values for the frequency of the feedback metric than an expected number of values by comparing the total measurement points in that histogram bin and values above a tolerable value.

17. The computer-implemented method of claim 15, wherein the computer program code further comprises sets of instructions executable by the one or more processors to:
determining data points where the feedback metric is equal to or below a tolerance threshold; and
removing the data points below the tolerance threshold such that they are not used to generate the histogram.

18. The computer-implemented method of claim 17, wherein the computer program code further comprises sets of instructions executable by the one or more processors to:
determining the bins of the histogram are equidistant; and
dividing, after removing the data points below the tolerance threshold, a number of data points in each bin by a total number of data points in the corresponding bin if the bins are equidistant.

19. The computer-implemented method of claim 17, wherein the computer program code further comprises sets of instructions executable by the one or more processors to:
calculating an expected mass of data points per bin; and
calculating a likeliness for a deviation between the mass for each particular bin and an average mass per bin, wherein a likeliness equal to or below a likeliness threshold value indicates that the poor performance of the one or more software applications is not a coincidence.

20. The computer-implemented method of claim 15, wherein the one or more software applications are operated by a cloud computing platform, and wherein reallocation of the resources for the one or more software applications includes reserving memory of the cloud computing platform for the one or more software applications; and
wherein software metrics for the one or more software applications include metrics for one or more of out of memory dumps, other memory shortages or events, software crashes, and metrics associated with performance issues.
